(19) United States
(12) Patent Application Publication
(10) Pub. No.: US 2006/0218139 A1
(43) Pub. Date: Sep. 28, 2006

(54) Document management apparatus and method

(75) Inventors: Kazuyuki Goto, Kanagawa-ken (JP); Hideo Umeki, Kanagawa-ken (JP); Tomoo Ikeda, Kanagawa-ken (JP); Takehiko Yokota, Tokyo (JP); Sogo Tsuboi, Kanagawa-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/266,271

(22) Filed: Nov. 4, 2005

(30) Foreign Application Priority Data
Mar. 25, 2005 (JP) P2005-089480

(51) Int. Cl. G06F 17/30

(52) U.S. Cl. 707/5

(57) ABSTRACT

A document operation unit operates on a plurality of documents in response to a user's operation request. A document relation data acquirement unit acquires relation data among the plurality of documents. The relation data includes an identifier of the user, a date of an operation, a kind of the operation, and a task as an operation purpose. A document relation data memory stores the relation data. An indication unit indicates a task in response to a user's indication request. A document evaluation unit retrieves the relation data including the indicated task from the document relation data memory, and assigns a value to each document based on the retrieved relation data. A document presentation unit presents at least one document having a larger value.

### CROSS-REFERENCE TO RELATED APPLICATIONS

This application is based upon and claims the benefit of priority from prior Japanese Patent Application No. 2005-89480, filed on Mar. 25, 2005; the entire contents of which are incorporated herein by reference.

### FIELD OF THE INVENTION

The present invention relates to a document management apparatus and a method for sharing documents such as an electronic mail by a plurality of users.

### BACKGROUND OF THE INVENTION

Usually, in various tasks such as design, business, and planning, by sharing useful knowledge and examples (an effective process for performing a task, an excellent method to write a document, or a rule to follow) among a plurality of users, an information system improves task efficiency and quality. In this system, task knowledge is documented as a resource of an organization and stored for management. Accordingly, the information system may be called a knowledge management system.

For example, in a work flow system supporting a defined form task such as a circulation of documents, each work of work flow and a task result such as a document are relationally managed. Furthermore, a task result from the past is reused for the same kind of new task. This technique is disclosed in Japanese Patent Disclosure (Kokai) 2002-230248 (page 3, FIG. 1) . . . (reference 1). In this reference, documents are stored with information such as a circulation history of work flow and a task property. By using the information as a retrieval key, a document related with the new task is retrieved.

On the other hand, based on a user's operation history and a relation between documents in case of creating or utilizing documents, retrieval and sharing of documents are supported. This technique is disclosed in Japanese Patent Disclosure (Kokai) 2002-117074 (pages 6 and 7, FIGS. 3, 10 and 11) . . . (reference 2). In this reference, a document is retrieved using relation data between documents. The relation data between documents includes a user identifier of a user who operated the relation between documents, a date of relation operation, a task and a purpose of relation operation, a comment, and a section (the user's belonging) utilizing the relation. This information is stored in correspondence with the documents. By using a relation matched with a retrieval condition in the stored information, a document corresponding to the relation is referred.

Furthermore, by recording a reuse history of a document, history information (who reused the document?, when the document was reused?, what document was created?) is presented to a user. This technique is disclosed in Japanese Patent Disclosure (Kokai) 2003-316822 (pages 5˜8, FIGS. 4 and 15) . . . (reference 3). In this reference, a similarity and a difference between an original document and a new document using the original document, and a further created document using the new document, are fedback to the user who provided the original document. As a result, the incentive to provide documents rises.

However, the above mentioned references include the following problems. First, in reference 1 (a method for sharing documents in cooperation with support of defined form task by the work flow system), undefined form task (work flow is undefined) and undefined documents (such as an electronic mail or a Web page) cannot be processed. Especially, in business activity over a plurality of tasks and sections (For example, large scale tasks mutually related such as market research, product planning, research and development, production control, and customer support), a document useful for some task cannot be selected from various kinds of many documents.

Furthermore, in references 2 and 3, a means for evaluating each document in many documents complicatedly related is not prepared. Accordingly, a useful document to be reused cannot be searched, and a document suitable for a user's task cannot be selected from many similar documents.

In reference 2, for example, a past document is retrieved using a task as a retrieval key. However, in case of many documents over a plurality of tasks, a useful document cannot be retrieved. In reference 3, a similarity and a difference between documents are detected using a base document. However, in case of many documents, a document having a large value cannot be decided. Originally, a comparison between documents having different contents and formats is meaningless.

Furthermore, when a user decides whether some document is usable, the user often wishes to refer a creation process of the document or an example using (use process) the document in the past. The creation process and the use process of the document can be referenced by tracing a work flow or an operation history. However, this process is very troublesome. In addition to this, reference to a history having small use value is useless.

In reference 2, a document directly related with some document can be referred. However, all relations among documents and the existence of useful documents must be examined by tracing each relation between documents in order. In reference 3, a reuse history of documents is displayed as a graph. However, a process that many documents are complicatedly related cannot be simply presented to the user. Even if a graph including a large value document and a small value document is displayed, it is complicated for the user. Briefly, it is desired that information to easily decide a value of a document for a user's task is presented to the user.

### SUMMARY OF THE INVENTION

The present invention is directed to a document management extraction apparatus and a method for selecting a document valuable for a user's task from a large number of documents.

According to an aspect of the present invention, there is provided an apparatus for managing documents, comprising: a document memory storing a plurality of documents; a document operation unit configured to operate on the plurality of documents in response to a user's operation request; a document relation data acquirement unit configured to acquire relation data among the plurality of documents as operation objects, the relation data including an identifier of the user, a date of an operation, a kind of the operation, and a task as an operation purpose; a document relation data memory storing the relation data; an indication unit configured to indicate a task in response to a user's indication request; a document evaluation unit configured to retrieve the relation data including the indicated task from said document relation data memory, and to assign a value to each of the plurality of documents based on the retrieved relation data; and a document presentation unit configured to present at least one document having the largest value from among the plurality of documents.

According to another aspect of the present invention, there is also provided a method for managing documents, comprising: operating on a plurality of documents in response to a user's operation request; acquiring relation data among the plurality of documents as operation objects, the relation data including an identifier of the user, a date of an operation, a kind of the operation, and a task as an operation purpose; storing the relation data in a document relation data memory; indicating a task in response to a user's indication request; retrieving the relation data including the indicated task from the document relation data memory; assigning a value to each of the plurality of documents based on the retrieved relation data; and presenting at least one document having the largest value from among the plurality of documents.

According to still another aspect of the present invention, there is also provided a computer program product, comprising: a computer readable program code embodied in said product for causing a computer to manage documents, said computer readable program code comprising: a first program code to operate on a plurality of documents in response to a user's operation request; a second program code to acquire relation data among the plurality of documents as operation objects, the relation data including an identifier of the user, a date of an operation, a kind of the operation, and a task as an operation purpose; a third program code to store the relation data in a document relation data memory; a fourth program code to indicate a task in response to a user's indication request; a fifth program code to retrieve the relation data including the indicated task from the document relation data memory; a sixth program code to assign a value to each of the plurality of documents based on the retrieved relation data; and a seventh program code to present at least one document having the largest value from among the plurality of documents.

### BRIEF DESCRIPTION OF THE DRAWINGS

FIG. 1 is a block diagram of the document management apparatus according to a first embodiment.

FIG. 2 is one example of user data stored in a user data memory 1 of FIG. 1.

FIG. 3 is one example of document data stored in a document data memory 3 of FIG. 1.

FIGS. 4A and 4B are one example of relation data stored in a document relation data memory 5 of FIG. 1.

FIG. 5 is one example of a document display on a document presentation unit 8 of FIG. 1

FIG. 6 is one example of a registration display on the document presentation unit 8.

FIG. 7 is one example of a list of used documents on the document presentation unit 8.

FIG. 8 is one example of a document retrieval display on the document presentation unit 8.

FIG. 9 is another example of the document retrieval display on the document presentation unit 8.

FIG. 10 is the other example of the document retrieval display on the document presentation unit 8.

FIG. 11 is one example of a summary display of task relation documents on the document presentation unit 8.

FIG. 12 is another example of the summary display of task relation documents on the document presentation unit 8.

FIGS. 13A and 13B are flow charts of processing of an evaluation unit 6 in FIG. 1.

FIG. 14 is a flow chart of processing of a document relation data summary unit 7 in FIG. 1

FIGS. 15A and 15B are examples of values of documents based on relation data between documents according to the first embodiment.

### DETAILED DESCRIPTION OF THE EMBODIMENTS

Hereinafter, various embodiments of the present invention will be explained by referring to the drawings. The present invention is not limited to following embodiments.

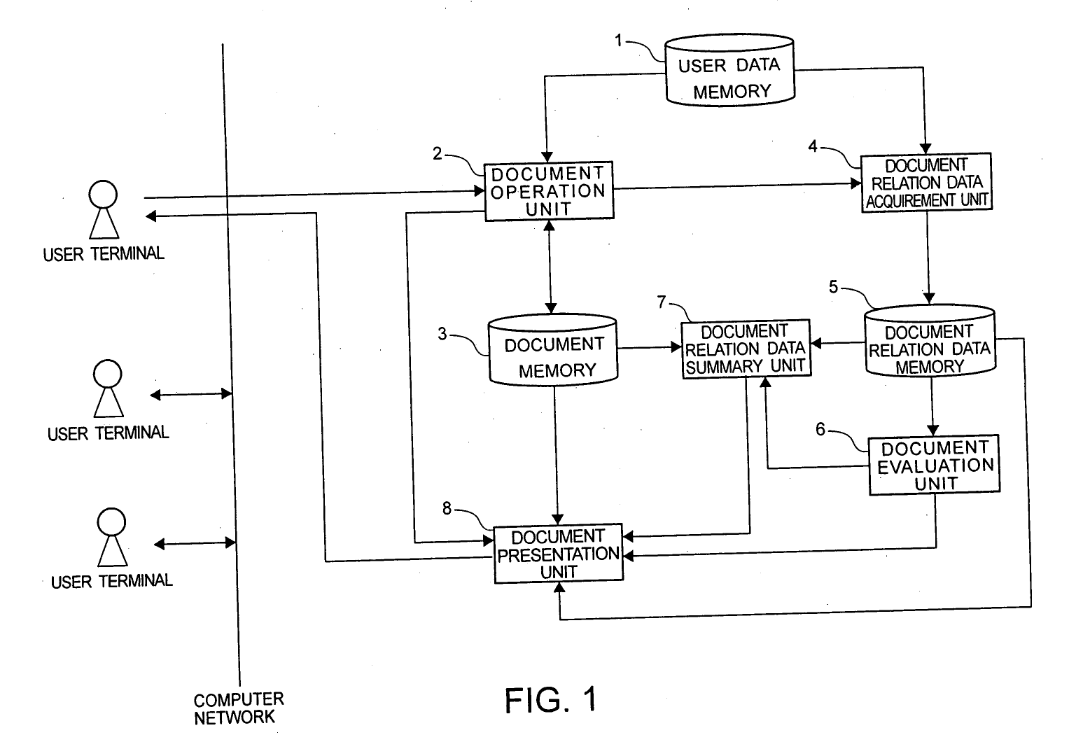

FIG. 1 is a block diagram of a document management system of a first embodiment. In the document management system of the first embodiment, a server computer executing various functions and a plurality of client terminal computers (user terminals) each utilizing the server computer are connected via a computer network. In FIG. 1, each function block 1-8 is realized by the server computer.

A user data memory 1 stores user data of a user utilizing this system, and executes user identification and access control of documents using the user data in the same way as a typical document management system. The user data identically describes creator data of documents and relation data between documents (explained afterward). A document operation unit 2 executes operation of documents in response to a user's operation request. Generally, the user's operation includes a registration, a deletion, a transmission, and a retrieval of documents. In addition to this, the user's operation includes a relation operation between documents such as “revision of a document by referring to another document”, “addition of a comment to a document” and “quotation from another document to a document”. Furthermore, by combining the document operation unit 2 with an electronic communication means such as an electronic mail or an electronic bulletin board, the document operation unit 2 may process operations such as sending and receiving electronic mail.

If the user's operation to the document operation unit 2 is registration of a document, a document memory 3 stores the document data. A document relation data acquirement unit 4 acquires the user's operation (for documents processed by the document operation unit 2) as relation data between the documents. A document relation data memory 5 stores the relation data between documents. A document evaluation unit 6 evaluates a value of each document using the relation data stored in the document relation data memory 5 (explained afterward). A document relation data summary unit 7 creates a summary of relation data between documents based on the evaluation result. A document presentation unit 8 presents a document of the user's request in cooperation with the document operation unit 2. In this case, based on a value of the document evaluated by the document evaluation unit 6, the document presentation unit 8 executes selection and sorting of documents to be presented, and presents the summary of the documents created by the document relation data summary unit 7.

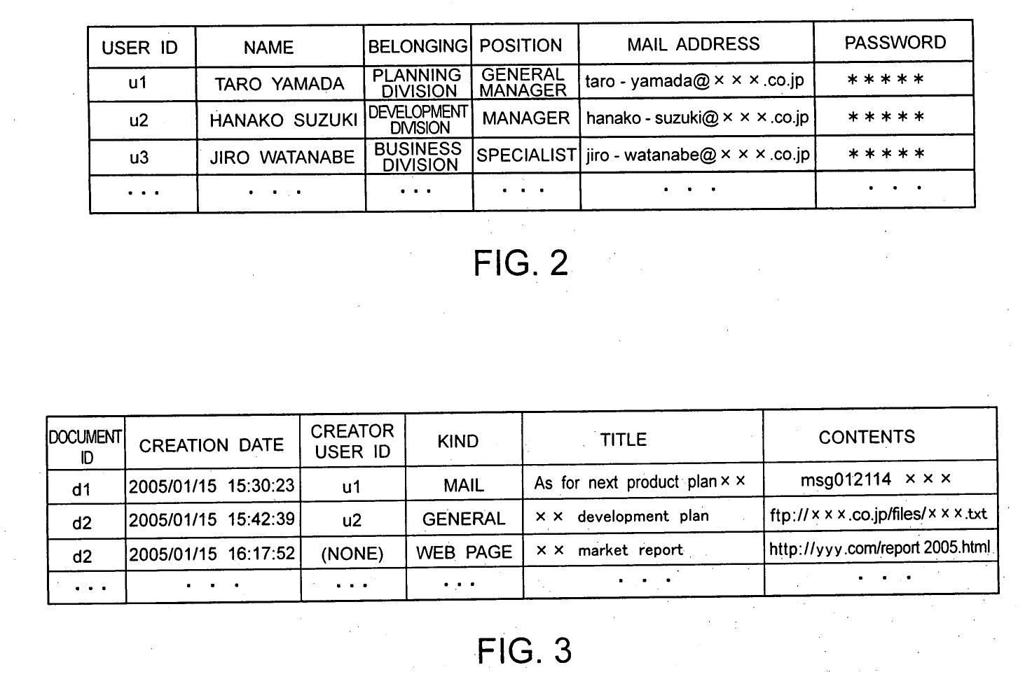

FIG. 2 shows one example of the user data stored in the user data memory 1 of FIG. 1. As shown in FIG. 2, a user ID (identifier) is uniquely assigned to each user data. The user data includes a user name, a belonging, a position, a mail address, and a password for identification.

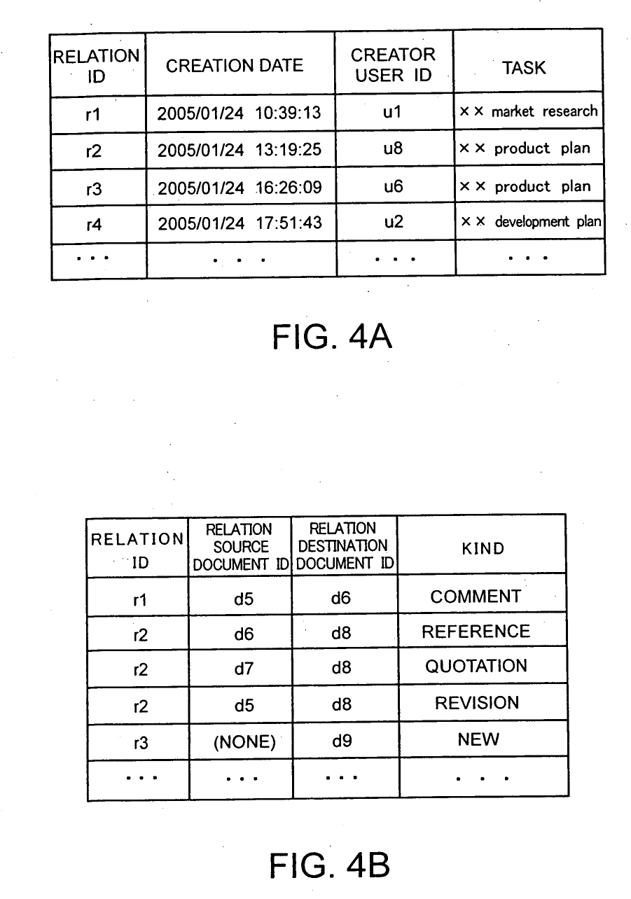

FIG. 3 shows one example of the document data stored in the document memory 3 of FIG. 1. As shown in FIG. 3, a document ID (identifier) is uniquely assigned to each document data. The document data includes a creation date of the document, a creator user ID, a kind of the document, a title, and contents of the document. The creator user ID is described as the user ID in the user data of FIG. 2. For example, as for a document created by not a user of this system, but by a Web page on the Internet, the creator user ID is not stored in the document memory 3. Furthermore, as for the contents of the document, all of electronic data is not necessarily stored in the document memory 3. For example, in the Web page on the Internet, electronic data is stored in a Web server. In this case, the document memory 3 may store URL of the electronic data. In FIG. 3, the contents are described as a URL or a message ID (in case of electronic mail).

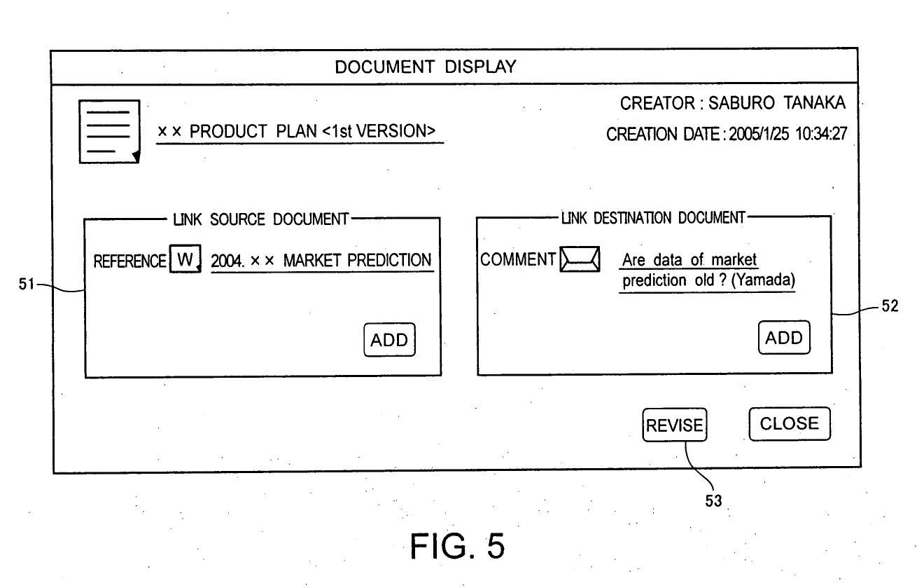

FIGS. 4A and 4B show one example of relation data between documents stored in the document relation data memory 5. A relation ID is uniquely assigned to each relation data. The relation data includes a creation date of relation data, a creator user ID, a task, a relation source document ID, a relation destination document ID, and a kind of relation. By the user's one operation, relation of multi to multi is created among a plurality of documents. For example, as shown in FIG. 4A, a relation ID “r2” represents a relation that a user of user ID “u8” created for a task “XX product plan” at a creation date “2005/01/24 13:19:25”. As shown in FIG. 4B, contents of the relation represents that a document of the relation source document ID “d6” is referenced, a document of the relation source document ID “d7” is quoted, and a document of the relation source document ID “d5” is revised as a new document of the document ID “d8”. Accordingly, the relation between two documents “d6” and “d8” is “reference”, the relation between two documents “d7” and “d8” is “quotation”, and the relation between two documents “d5” and “d8” is “revision”.

Furthermore, either a relation source document or a relation destination document often does not exist. For example, as shown in FIG. 4B, a relation source document ID is not recorded for a relation ID “r3”. This represents that an operation of the relation ID “r3” is creation of a new document having a document ID “d9” and no-relation with another document. In FIG. 1, the document relation data acquirement unit 4 acquires a task (in FIG. 4A) by which the user created the relation between documents. However, the task is often specified by the user's utilization status. In this case, based on a task of another relation including the relation source document or the relation destination document, a task of the relation may be estimated. If the task cannot be estimated, the system may ask the user to explicitly input task data.

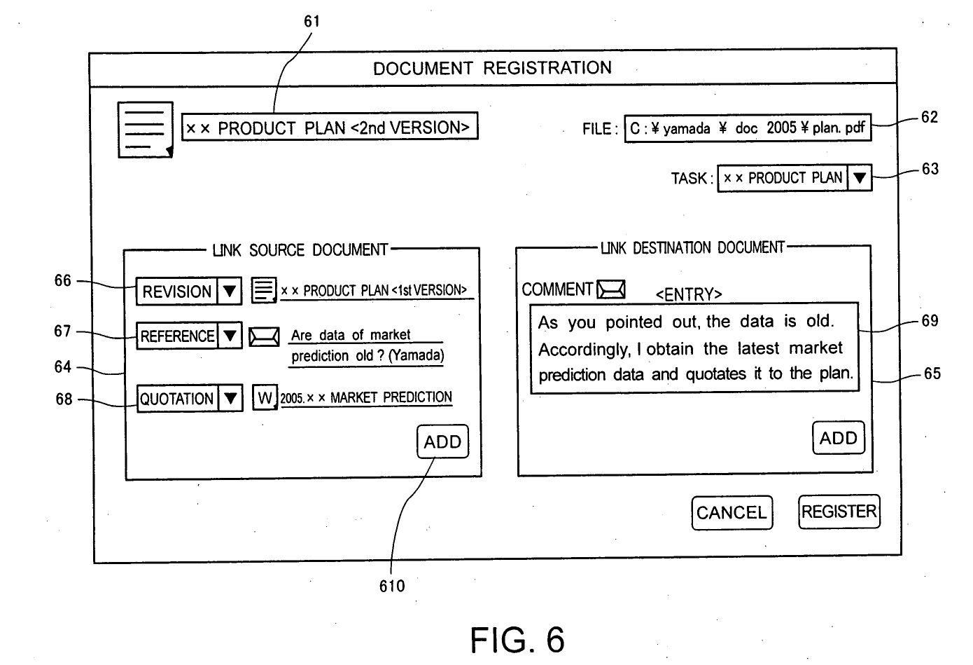

FIG. 5 shows one example of a document display presented to the user by the document presentation unit 8 of FIG. 1. In FIG. 5, as for a document “XX product plan <1st version>, a link (relation) source document 51 and a link (relation) destination document 52 are displayed with a creator's name and a creation date. These documents are presented based on the relation between documents stored in the document relation data memory 5, and directly related with “XX product plan <1st version>”. In an example of FIG. 5, a document (Web page) of “2004.XX market prediction” is displayed as the link source document used to create the document “XX product plan <1st version>”. On the other hand, as for the document “XX product plan <1st version>”, a comment “Are data of market prediction old?” is displayed as the link destination document added by a user “Yamada”.

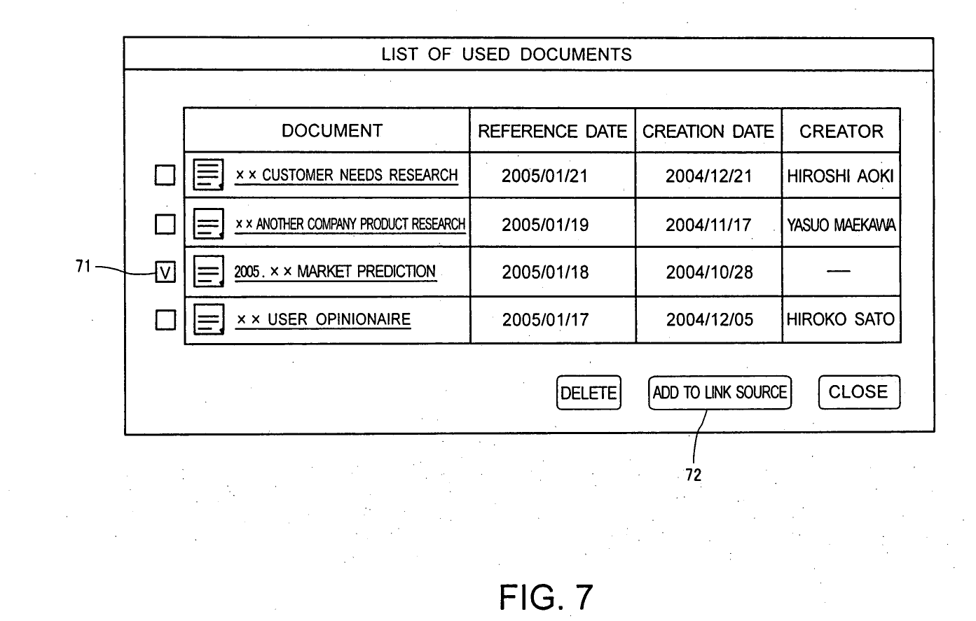

FIG. 6 shows one example of a registration display for the user to register a new document or a revised document. This example represents that the document of FIG. 5 is revised by pushing a button 53 “revise” of FIG. 5. The user registers a revised document to the system by setting a title 61 and a file 62. In this case, a link source document 64 and a link destination document 65 can be set. In FIG. 6, a pre-revised document is “XX product plan <1st version>” of FIG. 5. Accordingly, relation 66 “revision” is automatically displayed as a candidate of the link source document.

Furthermore, a comment 52 (of FIG. 5) added to the pre-revised document is often referred for revision. Accordingly, relation 67 “reference” is also displayed as a candidate of the link source document. The user may relate the revised document with link source documents, or may delete the link source documents if unnecessary.

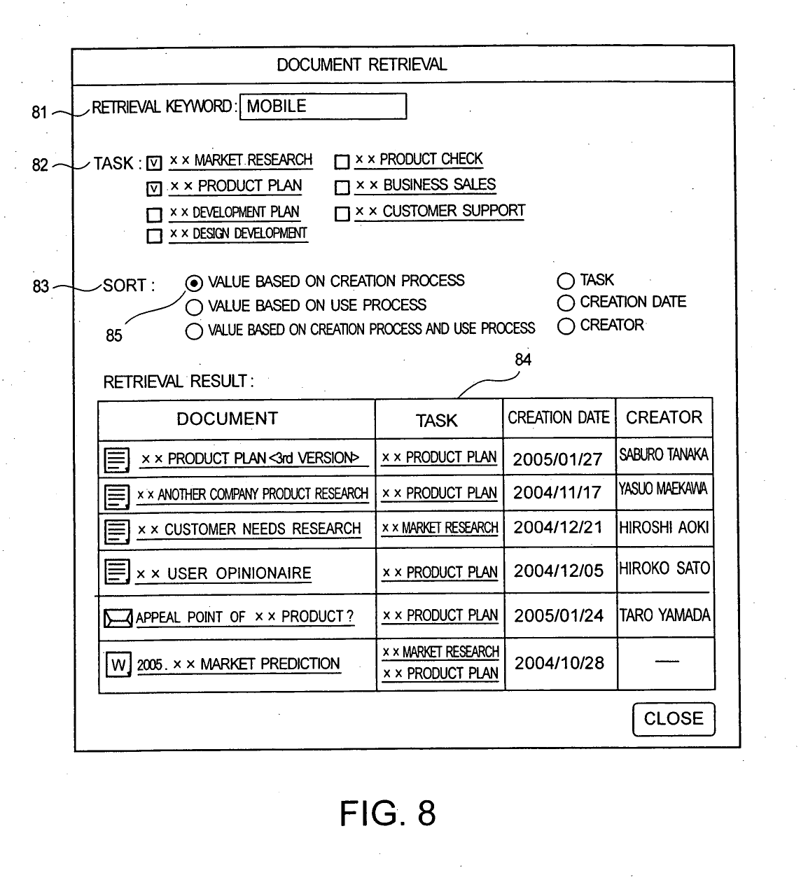

Furthermore, a kind of link (“revision”, “reference” and so on) may be changed by a pull down menu in FIG. 6. In addition to candidates of the link source document and the link destination document presented by the system, the user can relate an arbitrary document. For example, as shown in FIG. 7, a list of documents which the user utilized in the past is displayed. By selecting a document to be related as “reference” or “quotation” from the list, the user can explicitly add the document as a link source document. In FIG. 6, a document 68 “quotation” is added in this way.

A display of a list of used documents in FIG. 7 can be realized as follows. First, the user's operation received by the document operation unit 2 is temporarily stored for each user in a recent predetermined term. When the user creates a relation between documents, the list of used documents is presented by pushing a button 610 in FIG. 6. In FIG. 7, the user selects a document to be related by a check box 71, and adds the document as a link source document in FIG. 6 by pushing a button 72. On the other hand, a link destination document can be added in the same way as the link source document. For example, as for a link document (such as “comment”) often used for new registration or revision of documents, contents of the comment may be directly input through a screen as shown in “<entry>” 69 of FIG. 6.

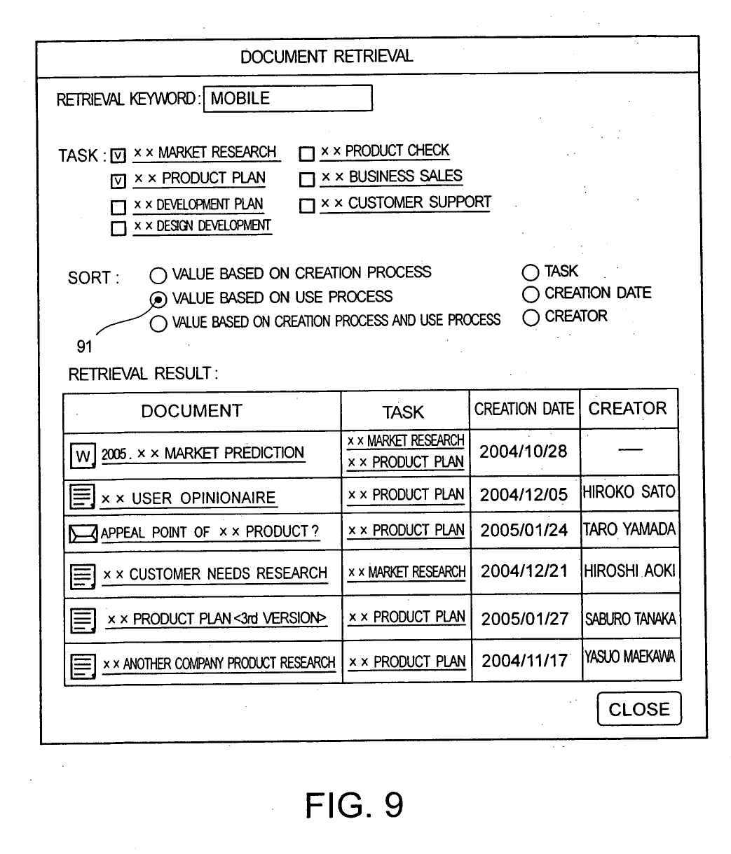

FIGS. 8, 9, and 10 show examples of a document retrieval display. In a prior document management system or a prior knowledge management system, a function of full text search by a retrieval condition such as a keyword or a natural language query, and a retrieval function by bibliography data (such as a creator's name or a creation date) as the retrieval condition, are normally set. In the present embodiment, sorting of documents as the retrieval result is executed using a value of each document based on the relation data.

In the document retrieval display of FIG. 8, a keyword of a retrieval condition is indicated as a retrieval keyword 81 in the same way as in the prior system. In addition to this, in the present embodiment, a task can be indicated as a retrieval condition. Briefly, as shown in task 82 of FIG. 8, the user can indicate documents created or utilized for the user's desired task as a retrieval object. As explained in FIG. 4A, task data is stored in correspondence with each relation data. Accordingly, documents related with a task indicated by the user are used as the retrieval object.

On the other hand, sort 83 of retrieval result (retrieved documents) is realized by the prior system. In addition to a sorting method by a creator's name or a creation date, sorting of documents by task can be realized. Briefly, in FIG. 8, a task 84 related with each document of retrieval result is presented. The retrieval result can be sorted using the task as a sort key. Furthermore, as a specific function of the present embodiment, sorting of a retrieval result by a value of each document can be executed. As explained afterward, a document having a large value is presented as a high rank of retrieval result using any of a value based on “creation process” of documents, a value based on “use process” of documents, and a value based on both “creation process” and “use process”.

FIG. 8 shows a screen on which a retrieval result of documents is sorted in larger order of a value 85 based on “creation process” of the documents. In general, a document created by referring to many fine data (or including fine opinion) has many intensive data and a high quality. A value evaluated from this viewpoint is the value based on “creation process” of the document. In the retrieval screen of FIG. 8, as a document having a large value, the plan and the report are displayed as high rank of the retrieval result.

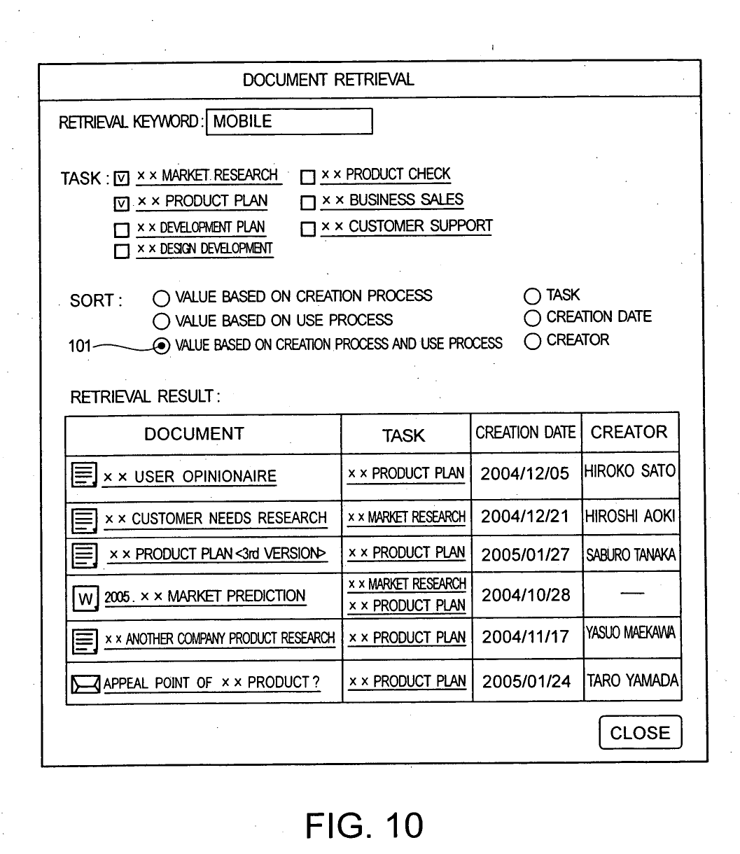

On the other hand, FIG. 9 shows a screen on which retrieval result of documents is sorted in larger order of the value 91 based on “use process” of documents. In general, a document utilized to create another document has a large utility or reusability. In the same way, for example, a mail describing a useful opinion to raise quality of a task result (document) is valuable in mails sent/received by the task. A value evaluated from this viewpoint is the value based on “use process” of the document. In the retrieval screen of FIG. 9, as a document having high value, a useful Web page, an opinionaire result and an important mail, are displayed as high rank of the retrieval result.

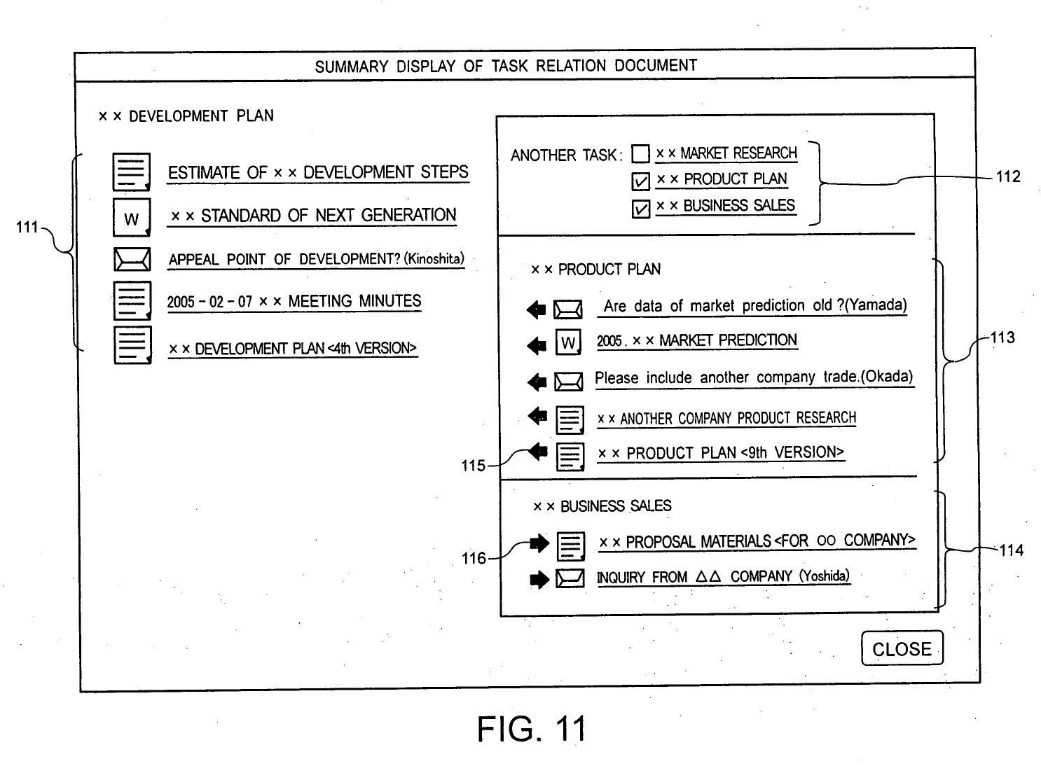

FIG. 10 shows a screen on which a retrieval result of documents is sorted in larger order of a value 101 based on “creation process” and “use process” of documents. Concretely, a document of which value evaluated by both “creation process” and “use process” is high (For example, the sum of both values) is displayed as high rank of the retrieved result.

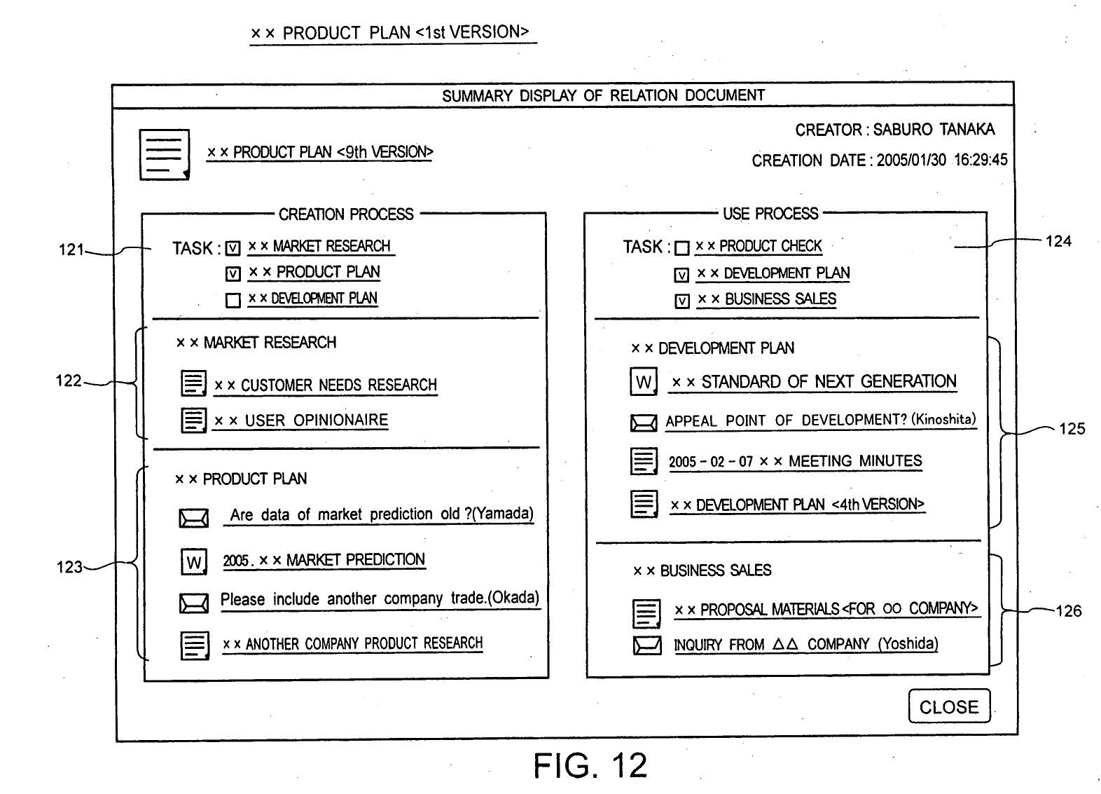

FIG. 11 shows one example of a screen on which a summary of relation data between documents related with some task is displayed. In general, many documents related with each task exist, and a user cannot easily search for an important document related to the user's desired task. In FIG. 11, in many documents related with task “XX development plan”, important documents are selected by a value evaluated based on relation data between documents, and summaries (titles) 111 of selected documents of predetermined number (easy for the user to watch) are displayed. This processing is almost the same as the retrieval processing of FIGS. 8, 9, and 10.

Furthermore, on this screen, other tasks 112 related with “XX development plan” are displayed. As for two tasks “XX product plan” and“XX business sales” selected from the other tasks by the user, a summary (titles) 115 and 116 of important documents related with the two tasks is displayed. In FIG. 11, a left direction arrow 115 marked with each document represents, for example, a document “XX product plan <9th version>” created for task “XX product plan” was used to create new document for task “XX development plan”. Conversely, a light direction arrow 116 represents, for example, a document created for task “XX development plan” was used to create a document “XX proposal materials <for OO company>” for task “XX business sales”. In this way, the summary (titles) of documents related with other tasks except for the user's selected task is displayed based on relation data (between documents) related with each task.

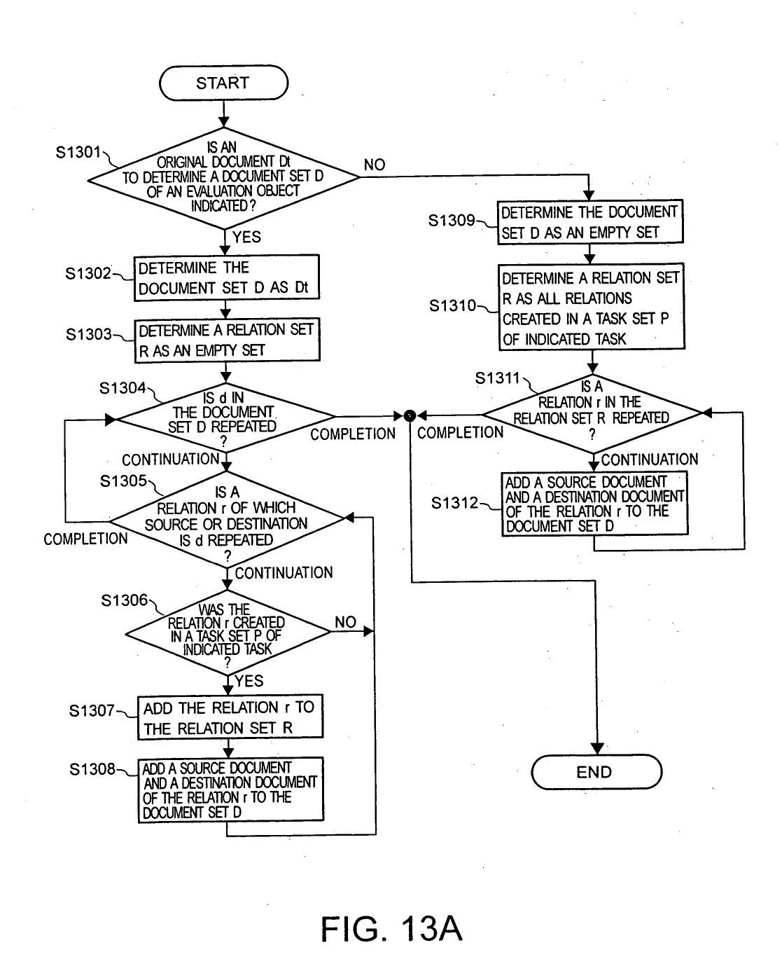

FIG. 12 shows one example of a display of summaries (titles) of documents related with tasks in “creation process” and “use process” of some document. As mentioned-above, in FIG. 5, the link source document and the link destination document each directly related with some document are displayed. The display status of FIG. 5 is useful for checking each relation between documents in detail or for reading/writing information (such as comment) for the document. However, this display status is not suitable for understanding other documents related with some document for all tasks. Accordingly, in FIG. 12, important documents related with tasks in “creation process” and “use process” are respectively displayed in order for the user to easily understand all tasks. In FIG. 12, tasks 121 related with documents (directly and indirectly) used to create a document “XX product plan <9th version>” are displayed. As for two tasks “XX market research” and “XX product plan” selected by the user, summaries (titles) of important documents 122 and 123 for the two tasks are displayed.

On the other hand, in FIG. 12, tasks 124 related with documents created using (directly and indirectly) the document “XX product plan <9th version>” are displayed. As for two tasks “XX development plan” and “XX business sales” selected by the user, summaries (titles) of important documents 125 and 126 for the two tasks are displayed. As mentioned-above, documents related with other tasks in “creation process” and “use process” of some document are displayed based on relation data of each task. In FIG. 12, relation data for one document “XX product plan <9th version>” are summarily displayed. However, relation data for a plurality of documents may be summarily displayed.

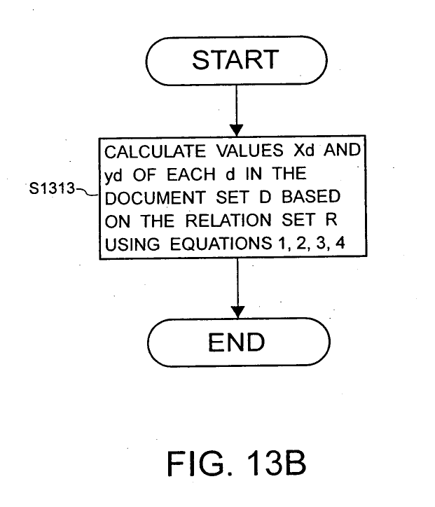

As mentioned-above, in FIGS. 5˜12, presentation function of the present embodiment is explained using screen examples utilized by the user. Hereinafter, processing to realize this function is explained. FIGS. 13A and 13B are flow charts of evaluation processing of a value of the document according to the present embodiment. This processing is executed by the document evaluation unit 6 in FIG. 1. Selection processing of documents to be presented and sort processing of the documents (explained in FIGS. 8˜10) as summarization of relation data are executed based on a value of the documents by the evaluation processing of FIG. 13A.

FIG. 13A is a flow chart of processing to determine a set D of documents to be evaluated and a set R of relation data (between documents) used for evaluation. Processing explained in FIG. 12 is a summarization of relation data between documents related with the user's selected task. In this case, at S1301 in FIG. 13, assume that an original document set to determine the set D of documents is indicated as Dₜ. In FIG. 12, a set including one document “XX product plan <9th version>” is Dₜ. First, the set D of documents is determined as Dₜ at S1302, and the set R of relation data is determined as an empty set at S1303.

Next, as for each document d in the set D, processing from S1304 to S1308 is repeatedly executed. First, relation r (relation ID) of which relation source document or relation destination document is d is extracted (S1305). The relation r is decided whether the relation r (relation ID) corresponds to any task of a task set P (indicated by the user) by referring to the relation data in FIGS. 4A and 4B (S1306). If the relation r corresponds to any task, the relation r (relation ID) is added to the set R. In FIG. 12, the user indicates the task set P (his desired task) through task selection items 121 and 124. However, if the user's desired task is not explicitly indicated, all relation R (all relation IDs) is selected for all tasks, and a result at S1306 is set as “Yes”. At S1307, a relation source document and a relation destination document (except for the document d) of the relation r is added to the set D. By repeating above-mentioned processing, as for a document set Dₜ and the task set P (each indicated by the user), the set D of documents to be evaluated and the set R of relation data used for evaluation are determined.

On the other hand, in processing explained by FIGS. 8˜11, all documents or documents related with some task are evaluated (“No” at S1301). Accordingly, processing from S1309 in FIG. 13A is executed. First, the set D of documents is determined as an empty set at S1309, and the set R of relation data is determined as all relation IDs corresponding to any task of the task set P (indicated by the user). In this case, the user indicates the task set P (the user's desired task) through task selection items 82 in FIG. 8. For example, in FIG. 11, a task “XX development plan” to create a summary of relation data is first indicated, and another task is further indicated from other task selection items 112. If a task is not explicitly indicated, the set R of relation data is determined for all tasks. As for each relation r (each relation ID) in the set R, a relation source document and a relation destination document corresponding to the relation r are added to the set D (S1311). By the above-mentioned processing, the set D of documents to be evaluated and the set R of relation data for evaluation are determined for the task set P (indicated by the user). FIG. 13B is a flow chart of evaluation processing of each document in the set D based on the set R (determined in FIG. 13A). Hereinafter, processing contents of S1313 is explained.

Equations (1), (2), (3), and (4), shown below, represent evaluation equations of a value of a document. In the equations, xi is a value based on “creation process” of a document i. If the document i is created using many documents each having a large value, a quality and a quantity of intensive information in the document i are regarded to be large. As a result, xi becomes a large value. On the other hand, yi is a value based on “use process” of a document i. If the document i is used to create many documents each having a large value, a utility and a reusability of the document i are regarded to be large. As a result, yi becomes a large value.
x′ᵢ^{<n>}=CₓₓΣ_{j:j-i}Wⱼᵢxⱼ^{<n-1>}+C_{xy}Σ_{j:j-i}Wⱼᵢyⱼ^{<n-1>} (1)
y′ᵢ^{<n>}=C_{yx}Σ_{j:i-j}Wᵢⱼxⱼ^{<n-1>}+C_{yy}Σ_{j:i-j}Wᵢⱼyⱼ^{<n-1>} (2)
xᵢ^{<n>}=x′ᵢ^{<n>}/√(Σⱼxⱼ^{<n>2}) (3)
yᵢ^{<n>}=y′ᵢ^{<n>}/√(Σⱼyⱼ^{<n>2}) (4)

In the equation (1), a value of xᵢ at n-times is xᵢ^{<n>}, values of a link source document j of the document i are xⱼ^{<n-1>} and yⱼ^{<n-1>}, a weight of link is Wⱼᵢ, and constants are Cₓₓ and C_{xy}. In order to calculate the value of xᵢ^{<n>}, the weight Wⱼᵢ is respectively multiplied with the values xⱼ^{<n-1>} and yⱼ^{<n-1>}, Wⱼᵢxⱼ^{<n-1>} and Wⱼᵢyⱼ^{<n-1>} are respectively summed, the constants Cₓₓ and C_{xy} are respectively multiplied with each sum, and each multiplied sum is added.

In the same way, in the equation (2), a value of yᵢ at n-times is yᵢ^{<n>}, values of a link destination document j of the document i are xⱼ^{<n-1>} and yⱼ^{<n-1>}, a weight of link is Wᵢⱼ, and constants are C_{yx} and C_{yy}. In order to calculate the value yᵢ^{<n>}, the weight Wᵢⱼ is respectively multiplied with the values xⱼ^{<n-1>} and yⱼ^{<n-1>}, Wᵢⱼxⱼ^{<n-1>} and Wᵢⱼyⱼ^{<n-1>} are respectively summed, the constants C_{yx} and C_{yy} are respectively multiplied with each sum, and each multiplied sum is added.

The equations (1) and (2) are recursively defined, and xᵢ^{<n>} and yᵢ^{<n>} are respectively calculated using xᵢ^{<n-1>} and yᵢ^{<n-1>}. Initial values xᵢ^{<0>} and yᵢ^{<0>} at “n=0” are set as “1” for all “i”, and values of xᵢ^{<n>} and yᵢ^{<n>} almost converge at calculation times “n=10”. In the equations (1) and (2), the left sides x′ᵢ^{<n>} and y′ᵢ^{<n>} are pre-normalized values of xᵢ^{<n>} and yᵢ^{<n>}. By using the equations (3) and (4), x′ᵢ^{<n>} and y′ᵢ^{<n>} are respectively normalized so that the square sum is “1”.

In the above equations, the weight Wᵢⱼ of link (relation data between documents) is determined by a kind and a date of operation for relation, a business career and a position of the user operating, and a condition whether the relation extends over a plurality of users, sections, and tasks. For example, if some document is utilized by another section (except for the user's section) in a company organization, this document has a utility higher than another document utilized by one section only. Furthermore, in comparison with two documents related with “comment”, two documents related with “quotation” have a large value to transfer from the relation source document to the relation destination document. In this way, by setting the weight Wᵢⱼ based on the document use method, a value of document can be more correctly evaluated.

In the sort method 83 of FIG. 8, the value based on “creation process” of document is represented as Xᵢ, and the value based on “use process” of document is represented as Yᵢ in the above equations. The value based on “creation process” and “use process” is calculated by “xᵢ+yᵢ”.

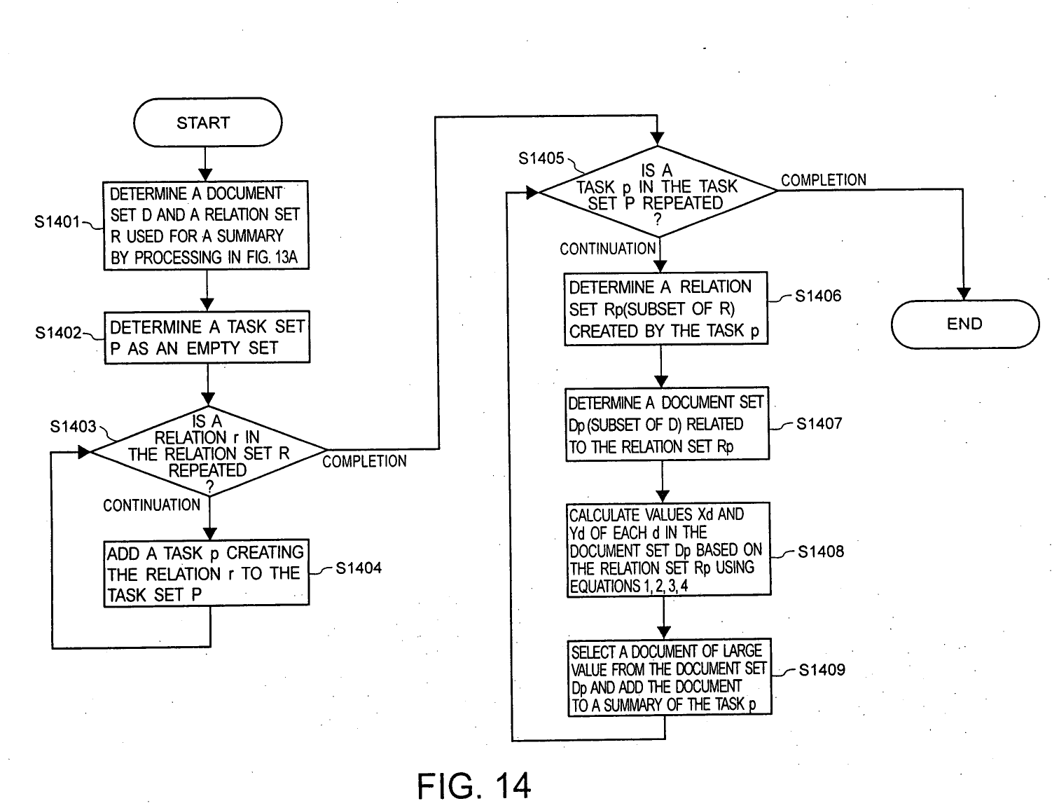

FIG. 14 is a flow chart of creation processing of a summary of relation data between documents according to the present invention. This processing is executed by the document relation data summary unit 7 in FIG. 1. First, a set D of documents to be evaluated and a set R of relation data between documents for evaluation are determined by the processing of FIG. 13A (S1401). A summary is respectively created for each task. Accordingly, a set P of tasks as the processing object is calculated by processing of S1402˜S1404. The set P of tasks is determined as an empty set (S1402). As for each relation r (relation ID) in the set R (S1403), a task corresponding to the relation r is selected and added to the set P (S1404). This processing is repeatedly executed for each task p in the set P (S1405), and a summary creation processing is executed.

First, a relation set Rₚ (including the relation r corresponding to the task p) is defined (S1406) The relation ser Rₚ is a subset of the set R. By referring to relation data in FIG. 4, a relation source document and a relation destination document corresponding to each relation of the relation set Rₚ are extracted and defined as a document set Dₚ. The document set Dₚ is a subset of the set D. Next, values x_{d} and y_{d} of each document d in the document set Dₚ are calculated by the processing of FIG. 13B. Based on the value of each document, documents having a large value are selected as a predetermined number (or documents having a value above predetermined value) from the document set Dₚ, and titles of the selected documents are added to a summary of the task p.

In this way, as shown in FIGS. 11 and 12, summaries 111, 113, 114, 122, 123, 125, and 126 of relation data of each task are created. In this case, titles of documents as the summary may be displayed in earlier order of creation date of each document or in larger order of value of each document. Furthermore, in FIG. 12, the summaries (titles of documents) are distinctly presented for the creation process 121 and the use process 124. This processing can be executed based on S1305 and S1308 in FIG. 13. Briefly, relation IDs to be added to the set R and documents to be added to the set D are respectively selected for the creation process (a direction to trace back a relation source) and the use process (a direction to trace a relation destination).

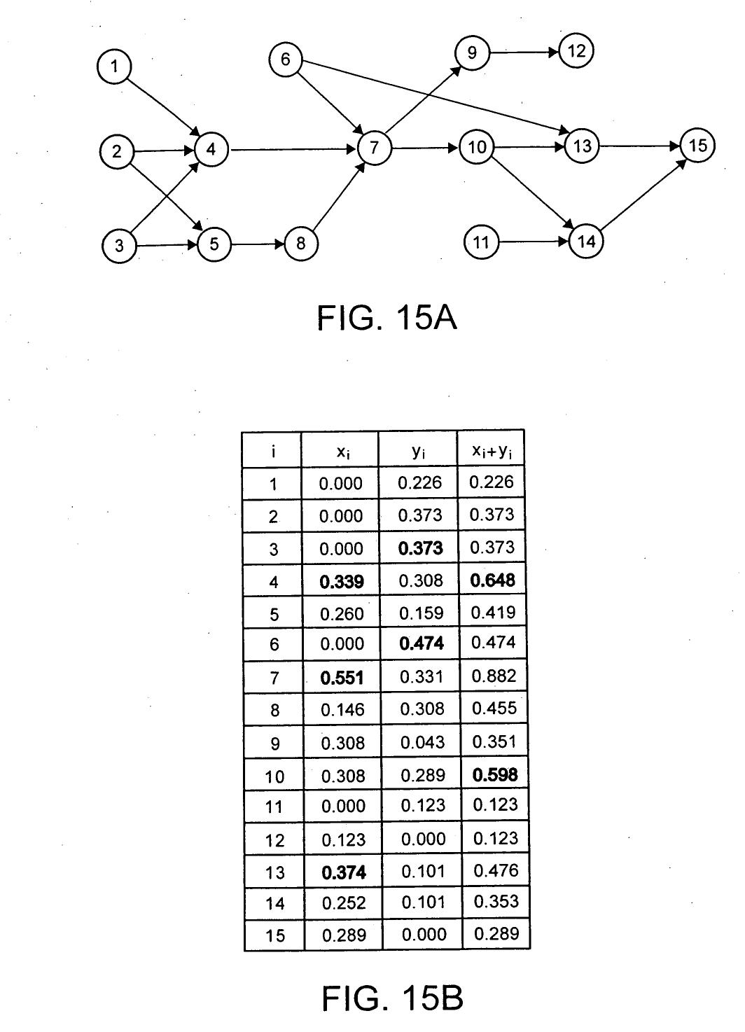

FIGS. 15A and 15B show calculation examples of the value of each document based on relation data between documents, which is an example result of processing explained in FIG. 13B. FIG. 15A is a graph of relation among documents. In FIG. 15A, nodes 1˜15 represent each document, and a link between two nodes represents a relation between two documents. Briefly, a start point of an arrow is a relation source document, and an end point of the arrow is a relation destination document. FIG. 15B lists values xᵢ and yᵢ of document i (i=1˜15) using above-mentioned equations (1), (2), (3), and (4). In order to simplify the calculation, all weights Wᵢⱼ of link are “1”, and all constants Cₓₓ, C_{xy}, C_{yx} and C_{yy} are “1”. As shown in FIG. 15B, a value xᵢ of a document 7 is the highest from a viewpoint of the creation process of document i. On the other hand, a value yᵢ of a document 6 is the highest from a viewpoint of the use process of document i. Totally, a value (xᵢ+yᵢ) of the document 7 is the highest. Intuitively, a value of a document having many relation source documents and many relation destination documents is high. In actual task, documents from tens to hundreds, or larger number of documents are complicatedly related to each other. In case of searching for a document of high value from such many documents or searching necessary document by tracing relation among documents, the user's working is very troublesome. Furthermore, such graph structure cannot be presented to the user as an understandable format.

As mentioned-above, in the present invention, a value of each document is automatically calculated based on relation data between documents. Furthermore, in addition to the value of each document, based on a process how the document was created and a process how the document was utilized in the past, documents important for the user's selected task are presented in an understandable format for the user. As a result, useful knowledge and information are effectively shared among a plurality of users, and efficiency and quality of tasks rise.

In the disclosed embodiments, the processing can be accomplished by a computer-executable program, and this program can be realized in a computer-readable memory device.

In the embodiments, the memory device, such as a magnetic disk, a flexible disk, a hard disk, an optical disk (CD-ROM, CD-R, DVD, and so on), an optical magnetic disk (MD and so on) can be used to store instructions for causing a processor or a computer to perform the processes described above.

Furthermore, based on an indication of the program installed from the memory device to the computer, OS (operation system) operating on the computer, or MW (middle ware software), such as database management software or network, may execute one part of each processing to realize the embodiments.

Furthermore, the memory device is not limited to a device independent from the computer. By downloading a program transmitted through a LAN or the Internet, a memory device in which the program is stored is included. Furthermore, the memory device is not limited to one. In the case that the processing of the embodiments is executed by a plurality of memory devices, a plurality of memory devices may be included in the memory device. The component of the device may be arbitrarily composed.

A computer may execute each processing stage of the embodiments according to the program stored in the memory device. The computer may be one apparatus such as a personal computer or a system in which a plurality of processing apparatuses are connected through a network. Furthermore, the computer is not limited to a personal computer. Those skilled in the art will appreciate that a computer includes a processing unit in an information processor, a microcomputer, and so on. In short, the equipment and the apparatus that can execute the functions in embodiments using the program are generally called the computer.

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

What is claimed is:

1. An apparatus for managing documents, comprising:
a document memory storing a plurality of documents;
a document operation unit configured to operate on the plurality of documents in response to a user's operation request;
a document relation data acquirement unit configured to acquire relation data among the plurality of documents as operation objects, the relation data including an identifier of the user, a date of an operation, a kind of the operation, and a task as an operation purpose;
a document relation data memory storing the relation data;
an indication unit configured to indicate a task in response to a user's indication request;
a document evaluation unit configured to retrieve the relation data including the indicated task from said document relation data memory, and to assign a value to each of the plurality of documents based on the retrieved relation data; and
a document presentation unit configured to present at least one document having the largest value from among the plurality of documents.

2. The apparatus according to claim 1,
wherein said document evaluation unit evaluates the value of each of the plurality of documents for at least one of a creation process and a use process of the operation.

3. The apparatus according to claim 2,
further comprising a document relation data summary unit configured to create a summary of the at least one document by referring to said document memory, and
wherein said document presentation unit presents the summary.

4. The apparatus according to claim 3,
wherein said document memory stores a document identifier, a creation date of a document, the identifier of the user as a creator, a kind of the document, a title of the document, and contents of the document, and
wherein the relation data further includes a relation identifier, the document identifier of a relation source, and the document identifier of a relation destination.

5. The apparatus according to claim 4,
wherein the kind of operation includes a reference, a quotation, a revision, a comment, and a new creation, and
wherein the summary includes the title of the document and the kind of operation.

6. The apparatus according to claim 5,
when said indication unit selects the document identifier of a document stored in said document memory in response to the user's selection request,
wherein said document relation data summary unit creates a summary of the document, a summary of a relation source document of the document, and a summary of a relation destination document of the document by referring to said document relation data memory, and
wherein said document presentation unit presents the summary of the document, the summary of the relation source document, and the summary of the relation destination document.

7. The apparatus according to claim 5, wherein,
when said indication unit indicates a registration of a document in response to the user's registration request,
said document presentation unit presents a list of documents used by the user, and
said indication unit selects at least one document to be related with the document from the list in response to the user's selection request.

8. The apparatus according to claim 5,
wherein said document presentation unit presents a plurality of selection items for document retrieval, the plurality of selection items including predetermined tasks, an evaluation value based on creation process, an evaluation value based on use process, and an evaluation value based on combination of creation process and use process.

9. The apparatus according to claim 8, wherein,
when said indication unit selects one task from the predetermined tasks and the evaluation value based on creation process,
said document evaluation unit retrieves document identifiers of relation source corresponding to the one task from said document relation data memory, retrieves documents of the document identifiers from said document memory, and evaluates a value of each of the documents.

10. The apparatus according to claim 8, wherein,
when said indication unit selects one task from the predetermined tasks and the evaluation value based on use process,
said document evaluation unit retrieves document identifiers of relation destination corresponding to the one task from said document relation data memory, retrieves documents of the document identifiers from said document memory, and evaluates a value of each of the documents.

11. The apparatus according to claim 8, wherein,
when said indication unit selects one task from the predetermined tasks and the evaluation value based on combination of creation process and use process,
said document evaluation unit retrieves document identifiers of relation source and relation destination corresponding to the one task from said document relation data memory, retrieves documents of the document identifiers from said document memory, and evaluates a value of each of the documents.

12. The apparatus according to claim 9, 10, or 11,
wherein said document presentation unit presents a predetermined number of the documents in order of the value of each document.

13. The apparatus according to claim 12,
wherein said document presentation unit additionally presents other tasks related with the one task, and
wherein, when said indication unit selects one of the other tasks in response to the user's selection request,
said document presentation unit presents a list of documents each of which relation data includes the one of the other tasks.

14. The apparatus according to claim 12,
wherein said document presentation unit presents a list of tasks of creation process of the document,
wherein, when said indication unit selects at least one task from the list in response to the user's selection request,
said document presentation unit presents a list of documents in larger order of the value, the documents having document identifiers of relation source corresponding to the at least one task in said document relation data memory.

15. The apparatus according to claim 12,
wherein said document presentation unit presents a list of tasks of use process of the document,
wherein, when said indication unit selects at least one task from the list in response to the user's selection request,
said document presentation unit presents a list of documents in larger order of the value, the documents having document identifiers of relation destination corresponding to the at least one task in said document relation data memory.

16. The apparatus according to claim 9,
wherein said document evaluation unit recursively calculates a value of a document by referring to a value of a relation source document used for creating the document.

17. The apparatus according to claim 10,
wherein said document evaluation unit recursively calculates a value of a document by referring to a value of a relation destination document created using the document.

18. The apparatus according to claim 11,
wherein said document evaluation unit recursively calculates a value of a document by referring to a value of a relation source document used for creating the document and a value of a relation destination document created using the document.

19. A method for managing documents, comprising:
operating on a plurality of documents in response to a user's operation request;
acquiring relation data among the plurality of documents as operation objects, the relation data including an identifier of the user, a date of an operation, a kind of the operation, and a task as an operation purpose;
storing the relation data in a document relation data memory;
indicating a task in response to a user's indication request;
retrieving the relation data including the indicated task from the document relation data memory;
assigning a value to each of the plurality of documents based on the retrieved relation data; and
presenting at least one document having the largest value from among the plurality of documents.

20. A computer program product, comprising:
a computer readable program code embodied in said product for causing a computer to manage documents, said computer readable program code comprising:
a first program code to operate on a plurality of documents in response to a user's operation request;
a second program code to acquire relation data among the plurality of documents as operation objects, the relation data including an identifier of the user, a date of an operation, a kind of the operation, and a task as an operation purpose;
a third program code to store the relation data in a document relation data memory;
a fourth program code to indicate a task in response to a user's indication request;
a fifth program code to retrieve the relation data including the indicated task from the document relation data memory;
a sixth program code to assign a value to each of the plurality of documents based on the retrieved relation data; and
a seventh program code to present at least one document having the largest value from among the plurality of documents.
